(19) United States
(12) Patent Application Publication
(10) Pub. No.: US 2019/0085545 A1
(43) Pub. Date: Mar. 21, 2019

(54) Touch Free Toilet

(71) Applicant: Dometic Sweden AB, Solna (SE)

(72) Inventor: Nathan A. Snyder, Big Prairie, OH (US)

(21) Appl. No.: 16/132,865

(22) Filed: Sep. 17, 2018

Related U.S. Application Data
(60) Provisional application No. 62/559,963, filed on Sep. 18, 2017.

(51) Int. Cl. E03D 5/10; G06F 3/01; E03C 1/05

(52) U.S. Cl. CPC E03D 5/105; G06F 3/0488; E03C 1/057; G06F 3/017

(57) ABSTRACT

Present embodiments relate to a control panel and method of use for a touch free mobile toilet, for example which may be used in an RV or a boat, for non-limiting example. The control panel is mounted remotely or spaced from the toilet on a stand or wall of the bathroom and may be wired or wirelessly connected to control the toilet. Alternatively, the control panel may be connected to the toilet. The control panel may include at least one sensor to control to detect preselected movements, for example hand movements, then convert such movement to a command function for the toilet operation.

### CLAIM TO PRIORITY

This non-provisional patent application claims priority to and benefit of, under 35 U.S.C. § 119(e), U.S. Provisional Patent Application Ser. No. 62/559,963, filed Sep. 18, 2017 and titled “Touch Free Toilet”, all of which is incorporated by reference herein.

### CROSS-REFERENCE

Cross-reference is made to U.S. Design Pat. Application No. 29/618,004 titled “Control Panel,” filed on Sep. 18, 2017 and which is expressly incorporated by reference herein.

### BACKGROUND

### Field of the Invention

Present embodiments are related to a touch free mobile toilet flushing control. More specifically, present embodiments relate to, without limitation, a remotely mounted control panel and methods of use for, providing touch free functionality for a mobile toilet.

### Description of the Related Art

Users of bathrooms prefer to limit touches of any bathroom surfaces in general for hygienic reasons. Some people may wrap their hands in toilet paper before touching any control actuators or even lifting a toilet seat. Alternatively, some people may lift the toilet seat with a shoe. This desire to limit touches is especially true for toilets and in particular for mobile toilets associated with camping, recreations vehicles (RVs) and boating. However, toilets associated with these types of activities may require additional functionalities or status indicators than standard residential and commercial toilets. Thus, there may be a potential for more touches of the toilet controls.

Despite a desire to not touch toilets and controls, these parts may become contaminated with germs and microbials. As a result, there is a continued desire to provide a method of controlling at least some function of a toilet in a touch free manner.

It may be desirable to overcome these and other issues with known mobile toilets, to limit touches of a mobile toilet.

The information included in this Background section of the specification, including any references cited herein and any description or discussion thereof, is included for technical reference purposes only and is not to be regarded subject matter by which the scope of the invention is to be bound.

### SUMMARY

The present application discloses one or more of the features recited in the appended claims and/or the following features which alone or in any combination, may comprise patentable subject matter.

Present embodiments relate to a control panel for a mobile toilet which may provide some hands-free functionality to limit touches of the toilet.

According to a first embodiment, a method of providing a hands-free function for flushing a mobile toilet may comprise providing a mobile toilet, providing a control panel having a sensor in the control panel and in communication with the toilet, remotely from the mobile toilet or connected to the toilet, detecting, by the sensor, a preselected hand movement, flushing the mobile toilet based on the sensor detecting the preselected hand movement and, filling the mobile toilet with the control panel.

According to some alternatives, any of the following options may be used with the method alone or in combination with one another. The method may further comprise providing a vacuum system for use with the toilet. The method may further comprise providing, at the control panel, a first indicator that vacuum is sufficient. The method may further comprise providing, at the control panel, a second indicator that the vacuum is insufficient. The method may further comprise providing at least one flush function actuator requiring touch. The method may further comprise providing a flush button. The method may further comprise providing an add water button.

According to a second embodiment, a method of providing a hands-free function for flushing a mobile toilet may comprise providing a mobile toilet, providing a control panel having a sensor in the control panel and in communication with the toilet, the control panel being remotely located, detecting, by the sensor, a preselected hand movement, flushing the mobile toilet based on the sensor detecting the preselected hand movement, and, providing a service indicator for vacuum system in communication with the mobile toilet.

According to some alternative, any of the following options may be used with the previous methods alone or in combination with one another. The method may further comprise providing at least one service indicator for the mobile toilet. The method may further comprise providing a waste tank level indicator on the control panel. The method may further comprise providing communication between a waste tank and the control panel.

According to a third embodiment, a remote control panel may comprise a housing, a printed circuit board having at least one sensor disposed within the housing, a face extending across the housing and hiding the printed circuit board, the sensor extending through one of the housing and the face, the sensor detecting preselected hand movements spaced from the control panel configured to flush a toilet in a touch-free manner, a touch actuator to flush the toilet, a service indicator for a vacuum system; and, a waste tank level indicator.

All of the above outlined features are to be understood as exemplary only and many more features and objectives of the touch free toilet may be gleaned from the disclosure herein. Therefore, no limiting interpretation of this summary is to be understood without further reading of the entire specification, claims and drawings, included herewith.

### BRIEF DESCRIPTION OF THE DRAWINGS

In order that the embodiments may be better understood, embodiments of the touch-free toilet will now be described by way of examples. These embodiments are not to limit the scope of the claims as other embodiments of the touch free toilet will become apparent to one having ordinary skill in the art upon reading the instant description. Non-limiting examples of the present embodiments are shown in figures wherein:

FIG. 1 is a schematic view of a waste system including one embodiment of a control panel providing touch-free function;

FIG. 2 is an exploded perspective view of an embodiment of the control panel;

FIG. 3 is a front view of an embodiment of an illustrative control panel; and,

FIG. 4 is a front view of an alternate embodiment of an illustrative control panel.

### DETAILED DESCRIPTION

It is to be understood that the touch free toilet is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

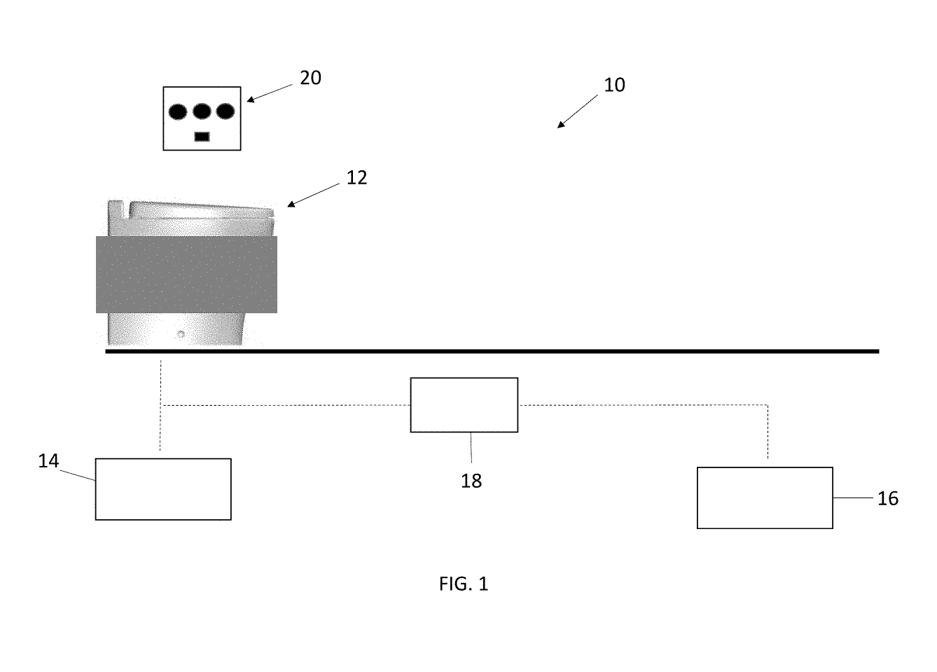

Referring now in detail to the drawings, wherein like numerals indicate like elements throughout several views, there are shown in FIGS. 1-4 various embodiments of a touch free toilet and method therefore. The present embodiments provide a control panel and method of use for a mobile toilet, which may be used in an RV or a boat, for non-limiting example. The control panel is mounted remotely or spaced from the toilet on a stand or wall of the bathroom and may be wired or wirelessly connected to control the toilet for control communication. Also, the control panel may be mounted to the toilet. The control panel may include at least one sensor to control to detect preselected movements, for example hand movements, and then convert such movement to a command function for the toilet operation.

The control panel may also comprise various indicators which indicate service status aspects of a waste system. For example, a waste tank level indicator when the waste tank level is ok, when it is full, or at any level between empty and full. Further, the control panel may have indicators indicating a flush capability, for example, with a vacuum system, when the system is pressurized to allow flushing or when the system pressure is not charged to flush.

The control panel may also utilize touch actuators, for example buttons, which require actuation for other functions. For example, one function may include, but is not limited to filling a toilet with water. Another function may include touch-actuated flush. Still another may include a service function, for non-limiting example.

Referring now to FIG. 1, is a schematic view of a mobile waste system 10 which may be used, without limitation, for a recreation vehicle (RV), a boat or the like. The system 10 comprises a toilet 12 which may be of various types of flushing technologies including gravity feed, vacuum flush, macerator, pressure jet and/or remote waste tank. In the instant schematic, the toilet 12 is shown schematically to be functioning in a gravity feed arrangement with a waste tank 14 directly beneath the toilet 12. In this embodiment, the function of the control panel 20 hands-free function may result in opening of a ball valve to remove contents of the bowl to the tank 14.

Further, the toilet 12 may also be a macerator toilet 12 with a remote waste tank 16. In this embodiment, waste materials are macerated, or ground with a pump and blade located within the housing of the toilet 12, and pumped to the remote waste tank 16.

In still other embodiments, the toilet 12 may be a vacuum assist toilet with an intermediate vacuum generator 18 and in further communication with the remote waste tank 16. The vacuum generator 18 creates a low pressure within the toilet system and provides a temporary storage for waste which is subsequently passed to the waste tank 16.

For simplicity sake, the gravity feed waste tank 14 is shown in fluid communication with the remote waste tank 16. This is not to be considered limiting as the waste tank 16 may be separately plumbed from the gravity feed waste tank 14. The figure is merely provided in this manner to show that the toilet 12 may be have various flush technologies, and a toilet 12 may be connected in a variety of manners.

Also shown in the schematic view is a control panel 20. The control panel 20 of the instant embodiments provides touch-free or touch-less functioning of at least some toilet function. It is desirable that at least some function, for example a toilet flush, be performed without touching the toilet or the control panel 20.

The instant embodiment provides that the control panel 20 may be in electrical communication with a controller on the toiler 12. The control panel 20 may be in wired connection, for example by Ethernet, RJ-45, RJ-12 or other means of wiring and/or connectivity. Alternatively, the control panel 20 may be remotely positioned from or may be wirelessly connected to the controller of the toilet 12, including wifi, Bluetooth, zigbee or others. In still further embodiments, wired and wireless communication may be utilized together. Also, in some embodiments, the control panel may be located on the toilet 12, for example on a base of the toilet or on a rear cover near the seat hinge.

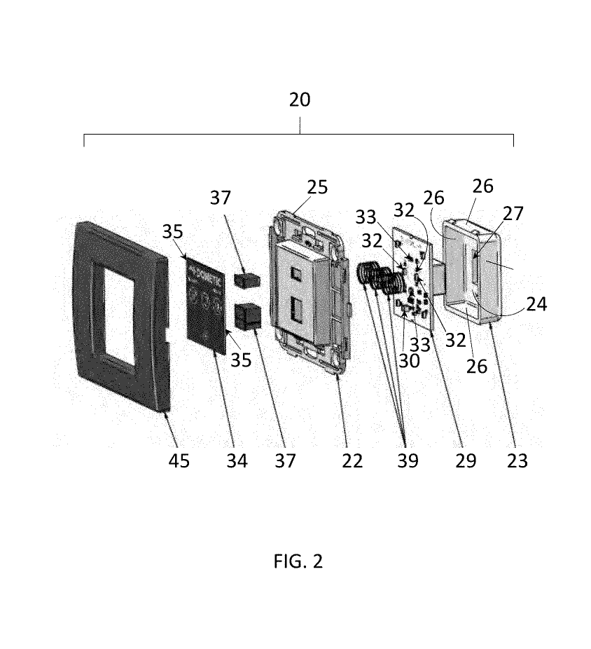

With reference to FIG. 2, an exploded perspective view of the control panel 20. The control panel 20 has at least one housing 22 which is shown generally as rectangular shaped. Various shapes may be utilized. Further, the instant embodiment provides a two piece housing, including a forward housing generally indicated at 22 and a rear housing 23. The forward and rear housing 22, 23 may be connected to provide an enclosure. Defined between the forward housing and rear housings 22, 23 may be a cavity 28 that receives the rear housing 23 wherein a frame 25 forward housing may be fastened or otherwise connected to a wall or substrate. The control panel 20 may be mounted on the surface of a wall in the bathroom or may be flush mounted in the wall in some embodiments. The housing includes a rear wall 24 and a plurality of sidewalls 26 which may be formed on either or both housings 22, 23. A cavity 28 may also define one or more mounting locations 27 for mounting of a printed circuit board 29. Within the cavity 28 (shown in the rear housing 23), the printed circuit board (PCB) 29 may be located with a sensor 30 and optionally, one or more actuator inputs 32. In some embodiments, three actuator inputs may be utilized. The number of inputs 32 may be dependent upon the type of flush technology being used and/or other factors.

Also disposed on the printed circuit board 29 may be one or more luminaires, such as for non-limiting example light emitting diodes (LEDs). The luminaires 33 may be indicators which illuminate messaging on the exterior of the control panel 20. Additionally, light tubes or pathways 37 may be used to move light in a controlled manner from the PCB 29 to a face 34.

One or more springs 39 are disposed between the face 34 and the PCB 29. The springs provide tactile feedback to the user that buttons 42, 43 have been depressed and may also function as contacts.

Spaced from the housing is a face 34. The face 34 may be disposed on an exterior of the cavity 28 or may enclose the cavity 28 of the housing 22 with the PCB 29 therein. The face 34 may include an opening for the sensor 30 and one or more buttons 42 which engage actuator inputs 32 when assembled.

The face 34 may also include a plurality of indicia 35 to which direct the user to status or condition of the toilet 12 or other portion of the waste system 10. For example, the indicia 35 may be illuminated when the control panel has power or not be illuminated when no power is provided to the control panel 20. Alternatively, other indicia may illuminate one color for one condition and a second color for a second condition. Alternatively, the indicia 35 may be illuminated by the luminaires only in selected conditions. Additionally, the face 34 may have buttons 42, 43 which cooperate with the inputs 32 to provide a signal to the PCB 29, to cause some toilet function to occur.

Disposed about the face 34 may be a bezel 45. The bezel 45 may surround the face 34 and hide the remainder of the control panel 20. This may be desirable to provide an aesthetically pleasing appearance. Further, the bezel 45 may be a solid opaque color or may be translucent or semi-translucent so that backlighting may be used to illuminate the bezel.

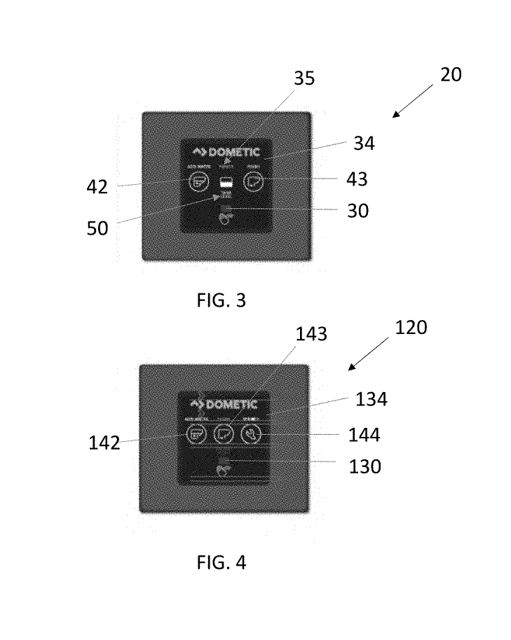

With reference now to FIG. 3, a front view of the face 34 of a first embodiment of the control panel 20. Depending on the type of toilet, the face 34 may have differing button functions or indicators. In the instant embodiment, the face 34 may be utilized with a macerator toilet. The face 34 includes the sensor 30, extending through from the PCB 29 (FIG. 2), which detects or senses movement of a user's hand in front of the face 34.

The movement may be a preselected motion such that the sensor 30 directs performance of a specific function. In the illustrative, non-limiting example, the waving of a hand in front of the sensor 30, results in the flushing of the toilet. Other functions however may be programmed to occur when the waving occurs. Alternatively, the other hand motions may be sensed to direct additional actions or functions. For example, a left-right movement may result in a flush, while a one directional movement or a vertical movement may result in a second directed function. Other functions which may be controlled include but are not limited to backlight controlling, flashing lighting, for example.

The face 34 also includes at least one button 42. In the instant embodiment, for example, the face 34 includes two buttons 42, 43. In the illustrative, non-limiting example, the buttons 42, 43 may provide a touch actuation for certain functions, for example “add water” and a “flush” function.

It may desirable to add water to the toilet bowl prior to a user using the bathroom. Also, it may be desirable to add water to the toilet or the waste system following a flush to add water for the next user, to rinse the system and add water to aid the macerator operation or limit malodorous smells from escaping to the toilet.

Also shown on the face 34 may be another indicia functioning as a waste tank level indicator 50. This indicator 50 may be one or more indicators. In the illustrative embodiment, the indicator 50 may change color rather than requiring two indicators. For example, if the waste tank level is below a threshold level, the indicator 50 may be a first color, for example, yellow or green. Alternatively, if the waste tank level is at or above the threshold level, the indicator 50 may be a second color, for example red.

With reference additionally to FIG. 1, multiple waste tanks 14, 16 are shown. The control panel 20 may have indicator for one or more of the waste tanks 14, 16. However, if indicating for both tanks, it may be desirable to be clear to the user which waste tank level is being indicated.

With reference now to FIG. 4, a second face 134 is shown. In this embodiment, the second face 134 is indicative of a vacuum flush system. In this embodiment, due the difference in flush technology, the face 134 of the control panel 120 may be indicated as having differing buttons on the face 134.

The instant embodiment may comprise a sensor 130 which detects one or more preselected hand motions. Upon detection, the toilet may flush based upon a command sent from the PCB 29 (FIG. 2) to the toilet 12 (FIG. 1).

The face 134 also include at least one button, and in the instant embodiment may include two buttons 142, 143. The buttons 142, 143 may include a flush function so that a touch-flush command is optionally provided. Additionally, in this embodiment, the vacuum flush system may include touch function to add water to the toilet, which may be desirable before using the restroom and aid to wash down the waste during the subsequent flush. Also, it may be desirable to add water to the bowl to inhibit malodorous smells from emanating to the interior of the vehicle from the waste tanks and associated plumbing.

In some embodiments, the face 134 may also include a button 144 which may be for a servicing function. For example, when this button 144 is pressed, a flush ball mechanism may be opened for cleaning and servicing of the toilet and vacuum system. Other servicing functions may occur during such servicing.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teaching(s) is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

What is claimed is:

1. A method of providing a hands-free function for flushing a mobile toilet, comprising:
providing a mobile toilet;
providing a control panel having a sensor in the control panel and in communication with the toilet, one of remotely from said toilet or connected to the toilet;
detecting, by the sensor, a preselected hand movement;
flushing the mobile toilet based on the sensor detecting the preselected hand movement; and,
filling the mobile toilet with the control panel.

2. The method of claim 1, further comprising providing a vacuum system for use with the toilet.

3. The method of claim 2, further comprising providing, at the control panel, a first indicator that vacuum is sufficient.

4. The method of claim 3, further comprising providing, at the control panel, a second indicator that the vacuum is insufficient.

5. The method of claim 1, further comprising providing at least one flush function actuator requiring touch.

6. The method of claim 5, further comprising providing a flush button.

7. The method of claim 5, further comprising providing an add water button.

8. A method of providing a hands-free function for flushing a mobile toilet, comprising:
providing a mobile toilet;
providing a control panel having a sensor in the control panel and in communication with the toilet, the control panel being remotely located;
detecting, by the sensor, a preselected hand movement;
flushing the mobile toilet based on the sensor detecting the preselected hand movement; and,
providing a service indicator for vacuum system in communication with the mobile toilet.

9. The method of claim 8 further comprising providing at least one service indicator for the mobile toilet.

10. The method of claim 8 further comprising providing a waste tank level indicator on the control panel.

11. The method of claim 10, further comprising providing communication between a waste tank and the control panel.

12. A remote control panel, comprising:
a housing;
a printed circuit board having at least one sensor disposed within the housing;
a face extending across the housing and hiding said printed circuit board;
said sensor extending through one of said housing and said face;
said sensor detecting preselected hand movements spaced from the control panel configured to flush a toilet in a touch-free manner;
a touch actuator to flush the toilet;
a service indicator for a vacuum system; and,
a waste tank level indicator.

13. The remote control panel of claim 12 further comprising a bezel surrounding said face.

14. The remote control panel of claim 13, said bezel being at least semi-translucent to provide an illuminated appearance.
